(19) United States
(12) Patent Application Publication
(10) Pub. No.: US 2023/0287192 A1
(43) Pub. Date: Sep. 14, 2023

(54) POLYAMIDE-BASED FILM HAVING AN IMPROVED COATING ADHESION PROPERTY AND PREPARATION METHOD THEREOF

(71) Applicant: SK microworks Co., Ltd., Gyeonggi-do (KR)

(72) Inventors: Sang Hun CHOI, Gyeonggi-do (KR); Hak Soo LEE, Gyeonggi-do (KR); Jin Woo LEE, Gyeonggi-do (KR)

(21) Appl. No.: 18/107,439

(22) Filed: Feb. 8, 2023

(30) Foreign Application Priority Data
Mar. 8, 2022 (KR) 10-2022-0029189

(51) Int. Cl. C08J 7/043; C09D 175/04; C09D 167/00

(52) U.S. Cl. CPC C08J 7/043; C09D 175/04; C09D 167/00; C08J 2377/10; C08J 2467/00; C08J 2375/04

(57) ABSTRACT

In the multilayer film provided with a primer layer of a specific composition comprising a polyester-based resin on a polyamide-based base layer, the adhesive strength with a hard coating layer and an OCA layer to be coated on the surface thereof is excellent, as well as the optical and mechanical properties are also excellent.

### CROSS-REFERENCE OF RELATED APPLICATIONS

This application claims priority to Korean Patent Application No. 10-2022-0029189 filed on Mar. 8, 2022, which is incorporated herein by reference in its entirety.

### TECHNICAL FIELD

The present invention relates to a polyamide-based film with improved coating adhesiveness and to a process for preparing the same.

### BACKGROUND ART

Display technologies continue to develop driven by the demand in tandem with the development of IT devices. In recent years, flexible display devices that can be flexibly bent or folded in response to an external force are preferred in the field of mobile devices that require large screens and portability at the same time. In particular, a foldable display device has the great advantages that it is folded to a small size to enhance its portability when not in use, and it is unfolded to form a large screen when in use.

A polymer film is preferred as a cover window for these flexible display devices. For example, polyamide-based films, such as polyamide-imide (PAI) films, are widely used since they are transparent, flexible, and excellent in mechanical properties.

However, such polyamide-based films are vulnerable to external scratches. In addition, further improvement is required in terms of such characteristics as anti-fingerprint and antistatic functions required for cover windows.

For example, Korean Patent No. 2147367 discloses a film for a cover window in which a hard coating layer and an anti-fingerprint layer are formed on a base layer made of a polyamide-imide (PAI) resin, which is applied to a flexible display.

### PRIOR ART DOCUMENT

### Patent Document

(Patent Document 1) Korean Patent No. 2147367

### DISCLOSURE OF INVENTION

### Technical Problem

A polyamide-based film currently used as a cover window of a flexible display device is used without surface treatment, or it is surface treated with a conventional primer. But it is difficult to secure adhesiveness with various functional layers such as a hard coating layer and an optically clear adhesive (OCA) layer that are coated or adhered to the surface thereof.

As a result of research conducted by the present inventors, therefore, it has been discovered that when a primer layer of a specific composition containing a polyester-based resin on a polyamide-based base layer, the adhesive strength with a functional coating layer such as a hard coating layer and an OCA layer is improved, as well as the optical and mechanical properties are also enhanced.

Accordingly, the present invention aims to provide a polyamide-based film with improved coating adhesiveness through primer treatment and a process for preparing the same.

### Solution to Problem

According to an embodiment, there is provided a multilayer film comprising a base layer comprising a polyamide-based polymer; and a primer layer formed on the base layer, wherein the primer layer comprises 60% by weight to 95% by weight of a polyester-based resin based on the total weight of the primer layer.

The multilayer film according to an embodiment is prepared by a process comprising preparing a base layer comprising a polyamide-based polymer; and coating a primer layer composition on the base layer and drying it, wherein the primer layer composition comprises a polymer resin and a solvent, and the polymer resin comprises 60% by weight to 95% by weight of a polyester resin based on the total solids content of the primer layer composition.

### Advantageous Effects of Invention

As the multilayer film according to the embodiment is provided with a primer layer of a specific composition that comprises a polyester-based resin on a polyamide-based base layer, the adhesive strength with a functional layer such as a hard coating layer and an OCA layer to be coated on the surface thereof is excellent, as well as the optical and mechanical properties are also excellent.

Accordingly, the multilayer film according to the embodiment can be provided with various functional layers such as a hard coating layer, an anti-fingerprint layer, an antistatic layer, an anti-glare layer, an anti-reflection layer, and an optically clear adhesive layer for implementing the characteristics required for a cover window of a display device such as a flexible display device.

### BRIEF DESCRIPTION OF DRAWINGS

FIG. 1 shows a cross-sectional view of a multilayer film according to an embodiment.

FIG. 2 shows a cross-sectional view of a multilayer film according to another embodiment.

FIG. 3 shows a cross-sectional view of a multilayer film according to still another embodiment.

FIG. 4 shows the evaluation criteria for a cross-cut test according to ASTM D3359 Method B.

FIG. 5 illustrates a 180° peel strength test method according to the ASTM D903 standard.

FIG. 6 illustrates a Sessile drop method for calculating surface energy.

### DESCRIPTION OF THE NUMERALS

3: test solution, 10a: sample (base layer), 10b: sample (functional layer), 10c: sample (surface), 11: multilayer film according to an embodiment, 12: multilayer film according to another embodiment, 13: multilayer film according to still another embodiment, 21: alignment plate, 22a: upper jig, 22b: lower jig, 100: base layer, 200: primer layer, 210: first primer layer, 220: second primer layer, 300: functional layer, 310: first functional layer, 320: second functional layer

### BEST MODE FOR CARRYING OUT THE INVENTION

Hereinafter, various embodiments and examples will be described in detail by referring to the drawings.

In the description of the following embodiments, if it is determined that a detailed description of a relevant known constitution or function may obscure the subject matter, the detailed description thereof will be omitted. In addition, the sizes of individual elements in the drawings may be exaggeratedly depicted or omitted for the sake of description, and they may differ from the actual sizes.

In the present specification, when one component is described to be formed on/under another component or connected or coupled to each other, it covers the cases where these components are directly or indirectly formed, connected, or coupled through another component. In addition, it should be understood that the reference for the on/under position of each component may vary depending on the direction in which the object is observed.

In this specification, terms referring to the respective components are used to distinguish them from each other and are not intended to limit the scope of the embodiment. In addition, in the present specification, a singular expression is interpreted to cover a plural number as well unless otherwise specified in the context.

In the present specification, the term “comprising” is intended to specify a particular characteristic, region, step, process, element, and/or component. It does not exclude the presence or addition of any other characteristic, region, step, process, element and/or component, unless specifically stated to the contrary.

In the present specification, the terms first, second, and the like are used to describe various components. But the components should not be limited by the terms. The terms are used for the purpose of distinguishing one element from another.

The molecular weight of a compound or polymer described in the present specification, for example, a number average molecular weight or a weight average molecular weight, is a relative mass based on carbon-12 as is well known. Although its unit is not described, it may be understood as a molar mass (g/mole) of the same numerical value, if necessary.

In the present specification, the term “substituted” means to be substituted with at least one substituent group selected from the group consisting of deuterium, —F, —Cl, —Br, —I, a hydroxyl group, a cyano group, a nitro group, an amino group, an amido group, a hydrazine group, a hydrazone group, an ester group, a ketone group, a carboxyl group, a substituted or unsubstituted C₁-C₃₀ alkyl group, a substituted or unsubstituted C₂-C₃₀ alkenyl group, a substituted or unsubstituted C₂-C₃₀ alkynyl group, a substituted or unsubstituted C₁-C₃₀ alkoxy group, a substituted or unsubstituted C₆-C₃₀ alicyclic organic group, a substituted or unsubstituted C₄-C₃₀ heterocyclic group, a substituted or unsubstituted C₆-C₃₀ aryl group, and a substituted or unsubstituted C₄-C₃₀ heteroaryl group. Two substituents adjacent to each other may be linked to form a ring.

Multilayer Film

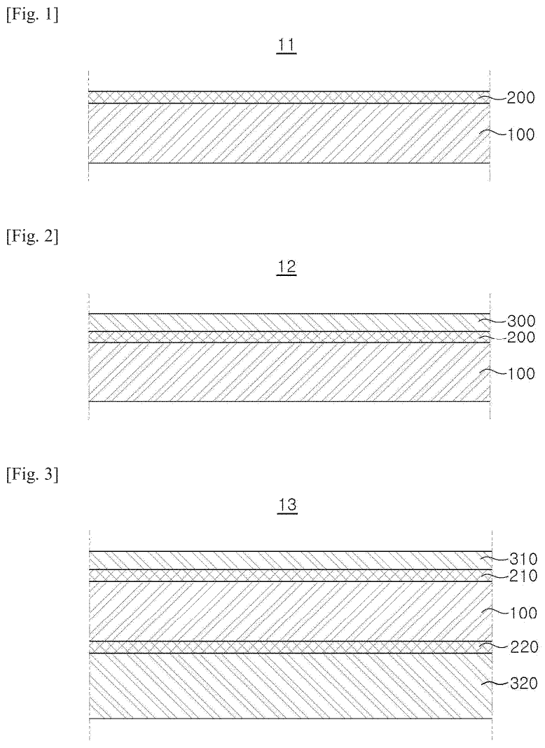

FIG. 1 shows a cross-sectional view of a multilayer film according to an embodiment.

Referring to FIG. 1, the multilayer film (11) according to an embodiment comprises a base layer (100) comprising a polyamide-based polymer; and a primer layer (200) formed on the base layer (100).

In an embodiment, the primer layer (200) comprises 60% by weight to 95% by weight of a polyester-based resin based on the total weight of the primer layer.

In addition, the primer layer may further comprise 5% by weight to 40% by weight of a polyurethane-based resin based on the total weight of the primer layer.

As the multilayer film according to an embodiment is provided with a primer layer of such a specific composition on a polyamide-based base layer, the adhesive strength with a functional layer such as a hard coating layer and an OCA layer to be coated on the surface thereof is excellent, as well as the optical and mechanical properties may also be enhanced. On the other hand, if the compositions of the base layer and the primer layer are outside the above ranges, the surface energy of the primer layer is lowered, which may deteriorate the optical and mechanical properties, as well as the adhesive strength with a functional layer such as a hard coating layer and an OCA layer to be coated or adhered to the surface thereof.

The process for preparing a multilayer film comprises preparing a base layer comprising a polyamide-based polymer; and coating a primer layer composition on the base layer and drying it.

In an embodiment, the primer layer composition comprises a polymer resin and a solvent, wherein the polymer resin comprises 60% by weight to 95% by weight of a polyester-based resin based on the total weight of the primer layer composition.

As an example, the solvent may comprise greater than 75% by weight of water and less than 25% by weight of isopropyl alcohol based on the total weight of the solvent.

As the primer layer has a certain level of surface energy, it has excellent adhesive strength to an adjacent layer.

For example, the surface energy of the primer layer may be 10 dynes or more, 20 dynes or more, 30 dynes or more, 35 dynes or more, 40 dynes or more, or 45 dynes or more, and 100 dynes or less, 90 dynes or less, 80 dynes or less, 70 dynes or less, 60 dynes or less, 55 dynes or less, or 50 dynes or less. As a specific example, the surface energy of the primer layer may be 30 dynes to 70 dynes. As a more specific example, the surface energy of the primer layer may be 35 dynes to 70 dynes, 35 dynes to 65 dynes, 35 dynes to 60 dynes, 35 dynes to 55 dynes, 35 dynes to 50 dynes, or 35 dynes to 45 dynes, but it is not limited thereto.

The surface energy may be measured by a method known in the art, for example, a Sessile drop method, but it is not particularly limited thereto. Referring to FIG. 6, in the Sessile drop method, the contact angle (Θ) of a test solution (3) to the surface of a sample surface (10c) is measured, and the surface energy of the sample is then calculated using the known surface tension of a test solution.

Accordingly, in the multilayer film according to an embodiment, the adhesive strength between the primer layer and the base layer may be very excellent.

For example, the cross-cut test result of the surface of the primer layer according to the ASTM D3359 standard may be 3B or more. Specifically, the cross-cut test result of the surface of the primer layer according to the ASTM D3359 standard may be 4B or more. More specifically, the cross-cut test result of the surface of the primer layer according to the ASTM D3359 standard may be 5B or more.

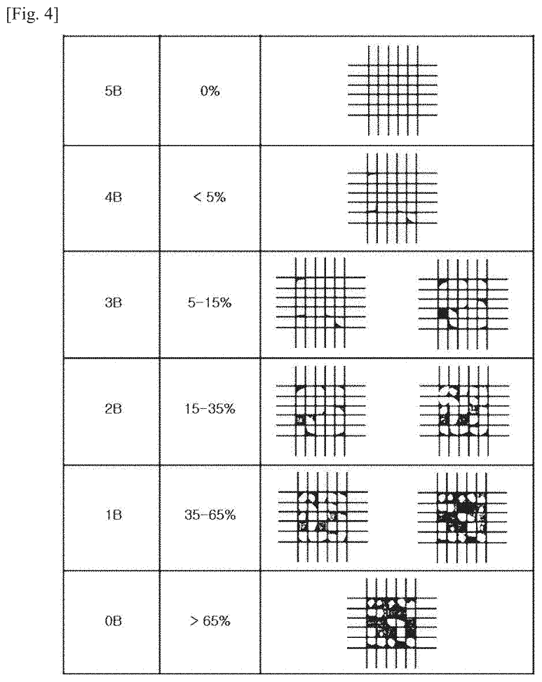

In the cross-cut test, the sample surface is cut in a grid shape at regular intervals, an adhesive tape is attached and then detached, and the number of grid units delaminated is counted. According to the ASTM D3359 standard (Method B), it is evaluated by dividing it into five grades (0B to 5B) according to the percentage of the number of grid units, which are not delaminated, to the total number of grid units. The higher the grade number, the more excellent the adhesive strength between the layers (see FIG. 4).

FIG. 2 shows a cross-sectional view of a multilayer film according to another embodiment.

Referring to FIG. 2, the multilayer film (12) may further comprise a functional layer (300).

In the multilayer film (12), the primer layer (200) may be interposed between the base layer (100) and the functional layer (300).

The functional layer may be a hard coating layer, an optically clear adhesive layer, a printing coating layer, an anti-fingerprint layer, an antistatic layer, an anti-glare layer, an anti-reflection layer, or the like, but it is not particularly limited thereto.

For example, the functional layer may be at least one selected from the group consisting of a hard coating layer, an optically clear adhesive layer, and a printing coating layer.

As a specific example, the multilayer film may have a structure of a hard coating layer, a primer layer, and a base layer.

As another specific example, the multilayer film may have a structure of a printing coating layer, a primer layer, and a base layer.

As another specific example, the multilayer film may have a structure of a base layer, a primer layer, and an optically clear adhesive layer.

FIG. 3 shows a cross-sectional view of a multilayer film according to still another embodiment.

Referring to FIG. 3, the multilayer film (13) may further comprise two or more functional layers (310, 320). In the multilayer film (13), a first primer layer (210) is interposed between the base layer (100) and the first functional layer (310), and a second primer layer (220) is interposed between the base layer (100) and the second functional layer (320).

As a specific example, the multilayer film may have a structure of a hard coating layer, a first primer layer, a base layer, a second primer layer, and an optically clear adhesive layer.

As a specific example, the multilayer film may have a structure of a printing coating layer, a first primer layer, a base layer, a second primer layer, and an optically clear adhesive layer.

As another specific example, the multilayer film may have a structure of a hard coating layer, a first primer layer, a base layer, a second primer layer, and a printing coating layer.

The first primer layer and the second primer layer may have the same composition and characteristics.

Alternatively, the first primer layer and the second primer layer may have a difference in composition and/or characteristics.

For example, the first primer layer may comprise a polyester-based resin, and the second primer layer may comprise a polyurethane-based resin. In addition, the first primer layer may have a thickness of, for example, 0.03 μm to 1.0 μm, and the second primer layer may have a thickness of, for example, 0.03 μm to 0.3 μm.

As a specific example, the first functional layer may be a hard coating layer, and the second functional layer may be an optically clear adhesive layer or a printing coating layer, but they are not limited thereto.

In the multilayer film, the adhesive strength between the functional layer and the base layer may be enhanced by the primer layer.

As an example, the hard coating layer or the printing coating layer formed on the primer layer may have further enhanced adhesive strength with the base layer through the primer layer. Specifically, the cross-cut test result of the surface of the hard coating layer or the printing coating layer according to the ASTM D3359 standard may be 3B or more or 4B or more, more specifically, 5B or more (see FIG. 4).

As another example, the optically clear adhesive layer formed by laminating an optically clear adhesive (OCA) sheet on the primer layer may have further enhanced adhesive strength with the base layer through the primer layer. Specifically, the optically clear adhesive layer may have a 180° peel strength of 0.8 kgf/inch or more to the base layer according to the ASTM D903 standard. More specifically, the peel strength may be 0.9 kgf/inch or more, 1.0 kgf/inch or more, or 1.1 kgf/inch or more. In addition, the upper limit of the peel strength is not particularly limited, but it may be, for example, 10 kgf/inch or less, 5 kgf/inch or less, 3 kgf/inch or less, or 2 kgf/inch or less. The peel strength may be obtained by measuring the load applied while peeling off two layers for which the adhesive strength is to be measured at 180° at a constant speed. The peel strength may be measured using a peel strength tester or a universal test machine.

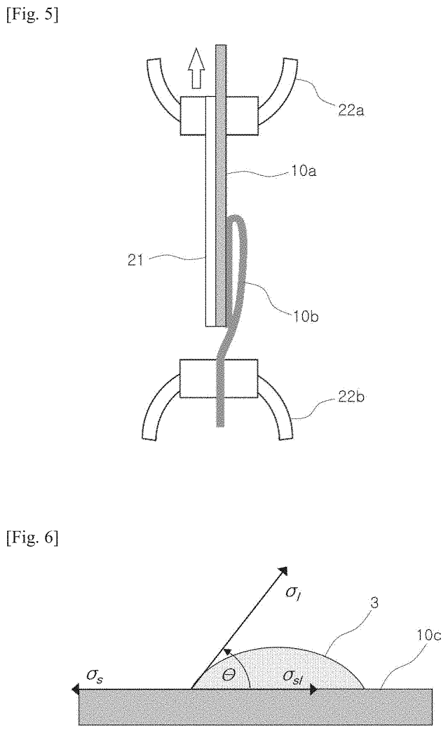

FIG. 5 illustrates a 180° peel strength test method according to the ASTM D903 standard. Referring to FIG. 5, the base layer (10a) of a sample is attached to an alignment plate (21) and fixed with an upper jig (22a), and then the functional layer (10b) of the sample to be measured for peel strength is fixed to a lower jig (22b). Thereafter, the upper jig (22a) is lifted at a constant speed to measure the load applied for obtaining peel strength while peeling off the functional layer (10b) from the base layer (10a) of the sample at 180°.

The multilayer film according to an embodiment is excellent in optical properties; thus, it is advantageous for being applied to a cover window of a display device.

The multilayer film according to an embodiment may have a light transmittance, for example, an average visible light transmittance of at least a certain level. For example, it may be 70% or more, 75% or more, 80% or more, 82% or more, 83% or more, 85% or more, 88% or more, 89% or more, or 90%, 46 or more. Meanwhile, the upper limit of the light transmittance range of the film is not particularly limited. It may be, for example, 100% or less, 95% or less, or 92% or less. The light transmittance may be measured, for example, using a haze meter NDH-5000W manufactured by Nippon Denshoku Kogyo in accordance with the JIS K 7136 standard.

In addition, the multilayer film according to an embodiment may have a haze of at a certain level or less. For example, it may be 5% or less, 4% or less, 3.5% or less, 3% or less, 2% or less, 1.5% or less, 1.2% or less, or 1% or less. Meanwhile, the lower limit of the haze range of the film is not particularly limited. It may be, for example, 0% or more or 0.5% or more. The haze may be measured, for example, using a haze meter NDH-5000W manufactured by Nippon Denshoku Kogyo in accordance with the JIS K 7136 standard.

In addition, the multilayer film may have a yellow index (YI) of 5 or less, for example, 4.5 or less, 4 or less, 3.8 or less, 3.5 or less, 3 or less, 2.8 or less, 2.5 or less, or 2.3 or less, but it is not limited thereto.

As a specific example, the multilayer film may have a haze of 3% or less, a light transmittance of 85% or more, and a yellowness (YI) of 5 or less.

Hereinafter, each constituent layer of the multilayer film according to the embodiment will be described in detail.

Primer Layer

The primer layer is formed on the base layer.

The primer layer comprises a polymer resin, for example, a curable resin, specifically, a thermosetting resin or a UV curable resin.

The polymer resin may form a solid structure of the primer layer through curing.

The primer layer may further comprise at least one polymer resin from a polyester-based resin, a polyurethane-based resin, an acrylic-based resin, a silicone-based resin, and an epoxy-based resin.

According to an embodiment, the primer layer comprises a polyester-based resin.

The content of the polyester-based resin in the primer layer may be 60% by weight to 95% by weight based on the total weight of the primer layer. For example, the content of the polyester-based resin in the primer layer may be 60% by weight or more, 65% by weight or more, 70% by weight or more, or 75% by weight or more, and 95% by weight or less, 90% by weight or less, 85% by weight or less, or 80% by weight or less.

Specifically, the content of the polyester-based resin in the primer layer may be 65% by weight to 95% by weight, 70% by weight to 95% by weight, or 70% by weight to 90% by weight, based on the total weight of the primer layer, but it is not limited thereto.

The polyester-based resin may be a homopolymer resin or a copolymer resin in which a dicarboxylic acid and a diol are polycondensed. In addition, the polyester-based resin may be a blend resin in which the homopolymer resins or the copolymer resins are mixed.

Examples of the dicarboxylic acid include terephthalic acid, isophthalic acid, orthophthalic acid, 2,5-naphthalene dicarboxylic acid, 2,6-naphthalene dicarboxylic acid, 1,4-naphthalene dicarboxylic acid, 1,5-naphthalene dicarboxylic acid, diphenylcarboxylic acid, diphenoxyethane dicarboxylic acid, diphenylsulfonic acid, anthracenedicarboxylic acid, 1,3-cyclopentanedicarboxylic acid, 1,3-cyclohexanedicarboxylic acid, 1,4-cyclohexanedicarboxylic acid, hexahydroterephthalic acid, hexahydroisophthalic acid, malonic acid, dimethyl malonic acid, succinic acid, 3,3-diethyl succinic acid, glutaric acid, 2,2-dimethylglutaric acid, adipic acid, 2-methyladipic acid, trimethyladipic acid, pimelic acid, azelaic acid, sebacic acid, suberic acid, dodecadicarboxylic acid, and the like.

In addition, examples of the diol include ethylene glycol, propylene glycol, hexamethylene glycol, neopentyl glycol, 1,2-cyclohexanedimethanol, 1,4-cyclohexanedimethanol, decamethylene glycol, 1,3-propanediol, 1,4-butanediol, 1,5-pentanediol, 1,6-hexanediol, 2,2-bis(4-hydroxyphenyl)propane, bis(4-hydroxyphenyl)sulfone, and the like.

As a specific example, the polyester-based resin may comprise a monomer composition of terephthalic acid and ethylene glycol. As another specific example, the polyester-based resin may comprise a monomer composition of terephthalic acid and neopentyl glycol. The polyester-based resin may have a weight average molecular weight (Mw) of, for example, 10,000 to 100,000 or 10,000 to 50,000. The polyester-based resin may have a hydroxyl group or a carboxyl group as a functional group.

According to another embodiment, the primer layer may further comprise a polyurethane-based resin. For example, the content of the polyurethane-based resin in the primer layer may be 5% by weight or more, 10% by weight or more, 15% by weight or more, or 20% by weight or more, and 40% by weight or less, 35% by weight or less, 30% by weight or less, 25% by weight or less, 20% by weight or less, or 15% by weight or less. Specifically, the primer layer may further comprise the polyurethane-based resin in an amount of 5% by weight to 35% by weight, or 10% by weight to 30% by weight, based on the total weight of the primer layer, but it is not limited thereto.

The polyurethane-based resin may be formed by a reaction of a diisocyanate compound and a polyol. The diisocyanate compound and the polyol may each comprise at least one of linear, branched, alicyclic, and aromatic compounds. The diisocyanate compound may specifically comprise at least one of a linear, branched, or alicyclic diisocyanate compound having 4 to 12 carbon atoms and an aromatic diisocyanate compound having 6 to 20 carbon atoms. The polyol may comprise two or more, for example, 2 to 4 hydroxyl groups (—OH). The polyol may specifically be a linear, branched, or alicyclic polyol compound having 4 to 12 carbon atoms or an aromatic polyol compound having 6 to 20 carbon atoms.

The polyurethane-based resin may comprise a urethane acrylate-based compound. Examples of the urethane acrylate-based compound include a bifunctional urethane acrylate oligomer having a weight average molecular weight of 1,400 to 25,000, a trifunctional urethane acrylate oligomer having a weight average molecular weight of 1,700 to 16,000, a tetra-functional urethane acrylate oligomer having a weight average molecular weight of 500 to 2,000, a hexa-functional urethane acrylate oligomer having a weight average molecular weight of 818 to 2,600, an ennea-functional urethane acrylate oligomer having a weight average molecular weight of 2,500 to 5,500, a deca-functional urethane acrylate oligomer having a weight average molecular weight of 3,200 to 3,900, and a pentakaideca-functional urethane acrylate oligomer having a weight average molecular weight of 2,300 to 20,000, but it is not limited thereto.

The urethane acrylate-based compound may have a glass transition temperature (Tg) of −80° C. to 100° C., −80° C. to 90° C., −80° C. to 80° C., −80° C. to 70° C., −80° C. to 60° C., −70° C. to 100° C., −70° C. to 90° C., −70° C. to 80° C., −70° C. to 70° C., −70° C. to 60° C., −60° C. to 100° C., −60° C. to 90° C., −60° C. to 80° C., −60° C. to 70° C., −60° C. to 60° C., −50° C. to 100° C., −50° C. to 90° C., −50° C. to 80° C., −50° C. to 70° C., or −50° C. to 60° C.

The primer layer may further comprise a photoinitiator.

Examples of the photoinitiator include 1-hydroxy-cyclohexyl-phenyl ketone, 2-hydroxy-2-methyl-1-phenyl-1-propanone, 2-hydroxy-1-[4-(2-hydroxyethoxy)phenyl]-2-methyl-1-propanone, methylbenzoylformate, α,α-dimethoxy-α-phenylacetophenone, 2-benzoyl-2-(dimethylamino)-1-[4-(4-morpholinyl)phenyl]-1-butanone, 2-methyl-1-[4-(methylthio)phenyl]-2-(4-morpholinyl)-1-propanone, diphenyl(2,4,6-trimethylbenzoyl)-phosphine oxide, and bis(2,4,6-trimethylbenzoyl)-phenylphosphine oxide, but it is not limited thereto. In addition, commercially available products include Irgacure™ 184, Irgacure™ 500, Irgacure™ 651, Irgacure™ 369, Irgacure™ 907, Darocur™ 1173, Darocur™ MBF, Irgacure™ 819, Darocur™ TPO, Irgacure™ 907, and Esacure™ KIP 100F. The photoinitiator may be used alone or in combination of two or more different types.

The photoinitiator may be employed in the primer layer in an amount of 1 to 10 parts by weight or 3 to 7 parts by weight, based on 100 parts by weight of the total weight of the polymer resin.

The primer layer is formed by coating a primer composition on the base layer and drying it.

The primer coating composition comprises a polymer resin and a solvent.

In an embodiment, the polymer resin comprises 60% by weight to 95% by weight of a polyester-based resin based on the total solids content of the primer layer composition. Specifically, the polymer resin may comprise the polyester-based resin in an amount of 65% by weight to 95% by weight, 70% by weight to 95% by weight, or 70% by weight to 90% by weight, based on the total solids content of the primer layer composition, but it is not limited thereto.

In addition, the polymer resin may further comprise 5% by weight to 30% by weight of a polyurethane-based resin based on the total solids content of the primer layer composition. Specifically, the polymer resin may further comprise the polyurethane-based resin in an amount of 10% by weight to 30% by weight based on the total solids content of the primer layer composition, but it is not limited thereto.

The content of the solvent is not particularly limited since it may be variously adjusted within a range that does not deteriorate the physical properties of the primer layer composition. For example, the content of the solvent may be such that the solids content in the primer layer composition is 1 to 50% by weight, specifically, 1 to 30% by weight, more specifically, 1 to 10% by weight.

Examples of the solvent include water; alcohol-based solvents such as methanol, ethanol, isopropyl alcohol, and butanol; alkoxy alcohol-based solvents such as 2-methoxyethanol, 2-ethoxyethanol, and 1-methoxy-2-propanol; ketone-based solvents such as acetone, methyl ethyl ketone, methyl isobutyl ketone, methyl propyl ketone, and cyclohexanone; ether-based solvent such as propylene glycol monopropyl ether, propylene glycol monomethyl ether, ethylene glycol monoethyl ether, ethylene glycol monopropyl ether, ethylene glycol monobutyl ether, diethylene glycol monomethyl ether, diethyl glycol monoethyl ether, diethylene glycol monopropyl ether, diethylene glycol monobutyl ether, and diethylene glycol-2-ethylhexyl ether; and aromatic solvents such as benzene, toluene, and xylene, which may be used alone or in combination thereof.

As an example, the solvent comprises water. Specifically, the content of water may be 50% by weight or more, 60% by weight or more, 70% by weight or more, 75% by weight or more, greater than 75% by weight, 80% by weight or more, or 85% by weight or more, and 100% by weight or less, less than 100% by weight, 99% by weight or less, 95% by weight or less, 90% by weight or less, or 85% by weight or less, based on the total weight of the solvent. More specifically, the content of water may be greater than 75% by weight to 100% by weight, greater than 75% by weight to less than 100% by weight, or 80% by weight to 95% by weight, based on the total weight of the solvent, but it is not limited thereto.

As another example, the solvent comprises isopropyl alcohol. Specifically, the content of isopropyl alcohol may be less than 50% by weight, 40% by weight or less, 30% by weight or less, 25% by weight or less, less than 25% by weight, 20% by weight or less, or 15% by weight or less, and greater than 0% by weight, 1% by weight or more, 5% by weight or more, 10% by weight or more, 15% by weight or more, or 20% by weight or more, based on the total weight of the solvent. Specifically, the content of isopropyl alcohol may be 0% by weight to less than 25% by weight, greater than 0% by weight to less than 25% by weight, or 5% by weight to 20% by weight, based on the total weight of the solvent, but it is not limited thereto.

As a specific example, the solvent may comprise greater than 75% by weight of water and less than 25% by weight of isopropyl alcohol based on the total weight of the solvent.

In addition, the primer layer composition may further comprise an additive such as a photoinitiator.

The surface energy of the primer layer composition may be 25 dynes to 40 dynes or 30 dynes to 40 dynes, but it is not limited thereto. The method described above or other known methods may be employed as a method for measuring the surface energy.

The primer coating composition may be applied through bar coating, knife coating, roll coating, blade coating, die coating, micro gravure coating, comma coating, slot die coating, lip coating, solution casting, or the like on a base layer, dried, and cured to form a primer layer.

The solvent contained in the primer coating composition may be removed through the drying step. The drying temperature may be 70° C. or higher, 90° C. or higher, or 110° C. or higher, for example, 70° C. to 200° C. or 90° C. to 150° C. The drying time may be, for example, 1 minute to 20 minutes, specifically, 1 minute to 10 minutes or 3 minutes to 7 minutes, but it is not limited thereto.

The curing of the primer layer may be carried out by light and/or heat. As an example, the primer layer may be subjected to UV curing, and the dose of light during UV curing may be 100 mJ or more, 200 mJ or more, or 300 mJ or more, for example, 100 mJ to 1,000 mJ or 300 mJ to 700 mJ. In addition, the curing may be partial curing or full curing.

The primer layer may have a thickness of 0.03 μm to 1.0 μm. For example, the thickness of the primer layer may be 0.03 m or more, 0.05 μm or more, 0.07 μm or more, 0.1 μm or more, 0.2 μm or more, 0.3 μm or more, 0.4 μm or more, or 0.5 μm or more, and 1.0 μm or less, 0.9 μm or less, 0.8 μm or less, 0.7 μm or less, 0.6 μm or less, 0.5 μm or less, 0.4 μm or less, 0.3 μm or less, 0.2 μm or less, or 0.1 μm or less. As a specific example, the thickness of the primer layer may be 0.03 μm to 0.1 μm or 0.1 μm to 0.5 μm.

Base Layer

The base layer serves as a base film of the primer layer while imparting mechanical properties to the multilayer film.

The base layer according to an embodiment comprises a polyamide-base polymer. Specifically, the base layer may be a transparent polyamide-based film. The polyamide-based polymer comprises an amide-based repeat unit. The amide-based repeat unit may be formed by polymerizing a diamine compound and a dicarbonyl compound. That is, the polyamide-based polymer may be prepared by simultaneously or sequentially reacting reactants that comprise a diamine compound and a dicarbonyl compound.

In some embodiments, the polyamide-based polymer may further comprise an imide-based repeat unit. Specifically, the polyamide-based polymer may be a copolymer comprising an amide-based repeat unit and an imide-based repeat unit, that is, a polyamide-imide-based polymer. The imide-based repeat unit may be formed by polymerizing a diamine compound and a dianhydride compound. That is, the polyamide-imide-based polymer may be prepared by simultaneously or sequentially reacting reactants that comprise a diamine compound, a dianhydride compound, and a dicarbonyl compound.

The diamine compound may form an imide bond with the dianhydride compound and form an amide bond with the dicarbonyl compound, to thereby form a polymer.

The diamine compound is not particularly limited, but it may be, for example, an aromatic diamine compound that contains an aromatic structure. For example, the diamine compound may be a compound represented by the following Formula 1.

H₂N-(E)ₑ-NH₂ [Formula 1]

In Formula 1, E is selected from a substituted or unsubstituted divalent C₆-C₃₀ aliphatic cyclic group, a substituted or unsubstituted divalent C₄-C₃₀ heteroaliphatic cyclic group, a substituted or unsubstituted divalent C₆-C₃₀ aromatic cyclic group, a substituted or unsubstituted divalent C₄-C₃₀ heteroaromatic cyclic group, a substituted or unsubstituted C₁-C₃₀ alkylene group, a substituted or unsubstituted C₂-C₃₀ alkenylene group, a substituted or unsubstituted C₂-C₃₀ alkynylene group, —C(═O)—, —CH(OH)—, —S(═O)₂—, —Si(CH₃)₂—, —C(CH₃)₂—, and —C(CF₃)₂—. e is selected from integers of 1 to 5. When e is 2 or more, the Es may be the same as, or different from, each other.

(E)ₑ in Formula 1 may be selected from the groups represented by the following Formulae 1-1a to 1-14a, but it is not limited thereto.

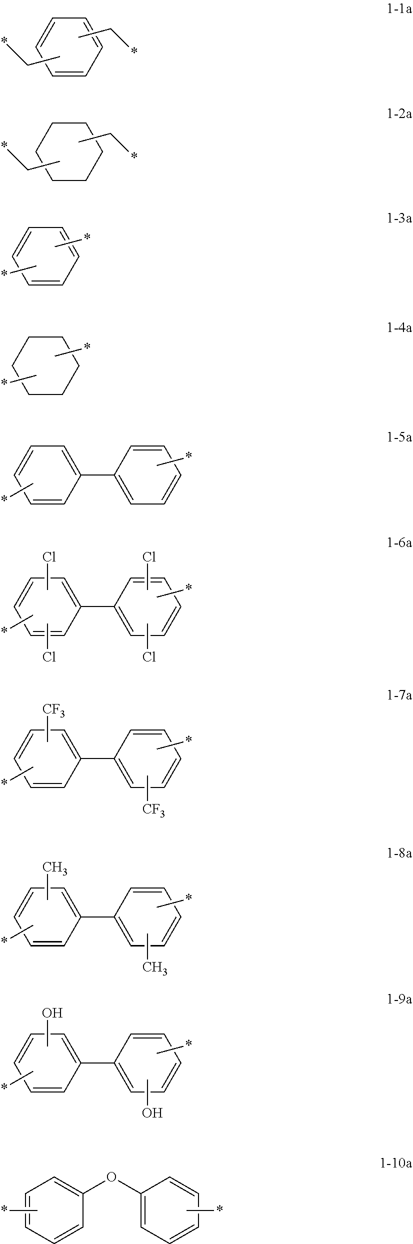

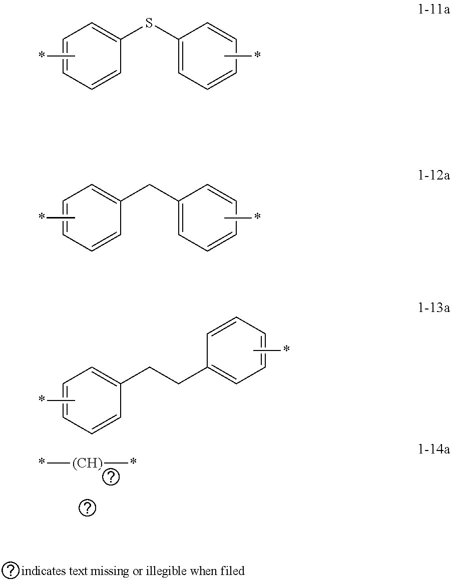

Specifically, (E)ₑ in Formula 1 may be selected from the groups represented by the following Formulae 1-1b to 1-13b, but it is not limited thereto.

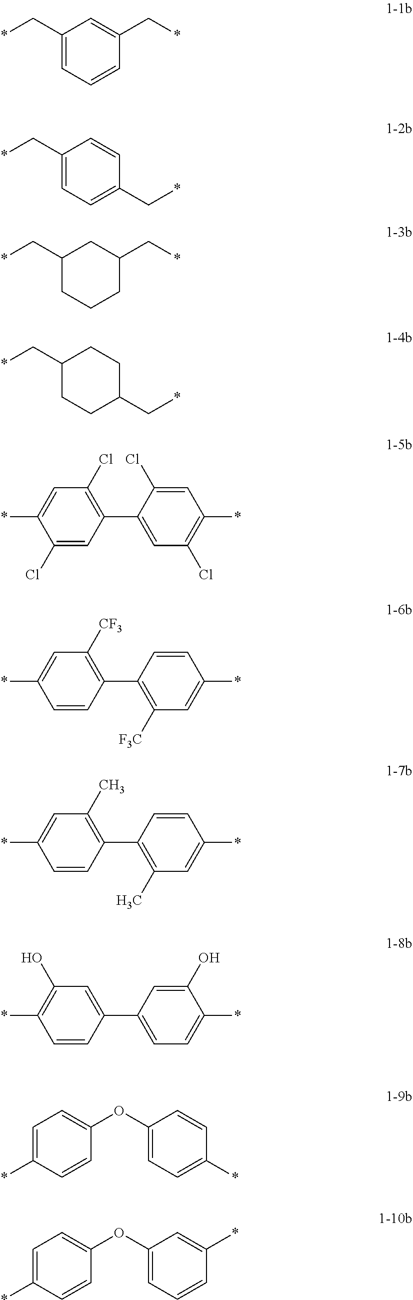

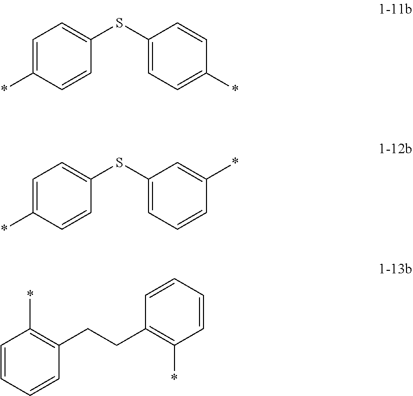 [SMILES: *c1ccc(Sc2ccc(*)cc2)cc1 ; *c1ccc(Sc2cccc(*)c2)cc1 ; *c1ccccc1CCc1ccccc1*]

More specifically, (E)ₑ in Formula 1 may be the group represented by the above Formula 1-6b or the group represented by the above Formula 1-9b.

In an embodiment, the diamine compound may comprise a compound having a fluorine-containing substituent or a compound having an ether group (—O—).

The diamine compound may be composed of a compound having a fluorine-containing substituent. In such an event, the fluorine-containing substituent may be a fluorinated hydrocarbon group and specifically may be a trifluoromethyl group. But it is not limited thereto.

In some embodiments, one kind of diamine compound may be used as the diamine compound. That is, the diamine compound may be composed of a single component.

For example, the diamine compound may comprise 2,2′-bis(trifluoromethyl)-4,4′-diaminobiphenyl (TFDB) represented by the following formula, but it is not limited thereto.

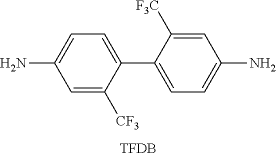

Since the dianhydride compound has a low birefringence value, it can contribute to enhancements in the optical properties such as transmittance of the film comprising an imide-based repeat unit.

The dianhydride compound is not particularly limited, but it may be, for example, an aromatic dianhydride compound that contains an aromatic structure. Specifically, the aromatic dianhydride compound may be a compound represented by the following Formula 2.

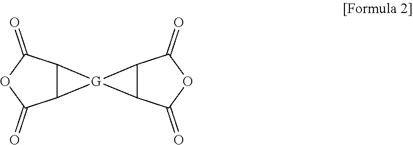

In Formula 2, G may be a group selected from a substituted or unsubstituted tetravalent C₆-C₃₀ aliphatic cyclic group, a substituted or unsubstituted tetravalent C₄-C₃₀ heteroaliphatic cyclic group, a substituted or unsubstituted tetravalent C₆-C₃₀ aromatic cyclic group, or a substituted or unsubstituted tetravalent C₄-C₃₀ heteroaromatic cyclic group, wherein the aliphatic cyclic group, the heteroaliphatic cyclic group, the aromatic cyclic group, or the heteroaromatic cyclic group may be present alone, may be fused to each other to form a condensed ring, or may be bonded by a bonding group selected from a substituted or unsubstituted C₁-C₃₀ alkylene group, a substituted or unsubstituted C₂-C₃₀ alkenylene group, a substituted or unsubstituted C₂-C₃₀ alkynylene group, —O—, —S—, —C(═O)—, —CH(OH)—, —S(═O)₂—, —Si(CH₃)₂—, —C(CH₃)₂—, and —C(CF₃)₂—.

G in the above Formula 2 may be selected from the groups represented by the following Formulae 2-1a to 2-9a, but it is not limited thereto.

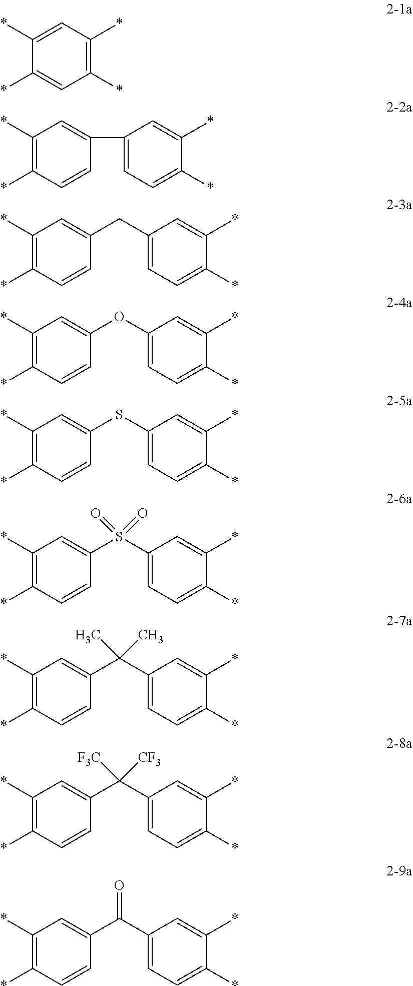

For example, G in Formula 2 may be the group represented by the above Formula 2-2a, the group represented by the above Formula 2-8a, or the group represented by the above Formula 2-9a.

In an embodiment, the dianhydride compound may comprise a compound having a fluorine-containing substituent, a compound having a biphenyl group, or a compound having a ketone group.

The fluorine-containing substituent may be a fluorinated hydrocarbon group and specifically may be a trifluoromethyl group. But it is not limited thereto.

In another embodiment, the dianhydride compound may be composed of a single component or a mixture of two components.

For example, the dianhydride compound may comprise at least one selected from the group consisting of 2,2′-bis-(3,4-dicarboxyphenyl)hexafluoropropane dianhydride (6-FDA) and 3,3′,4,4′-biphenyltetracarboxylic dianhydride (BPDA), which have the following structures, but it is not limited thereto.

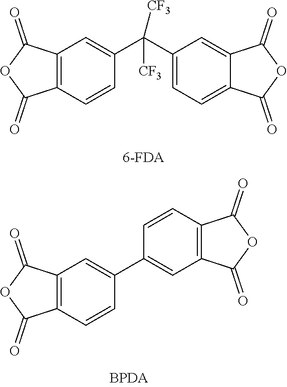 [SMILES: O=C1OC(=O)c2cc(C(c3ccc4c(c3)C(=O)OC4=O)(C(F)(F)F)C(F)(F)F)ccc21 ; O=C1OC(=O)c2cc(-c3ccc4c(c3)C(=O)OC4=O)ccc21]

The diamine compound and the dianhydride compound may be polymerized to form a polyamic acid.

Subsequently, the polyamic acid may be converted to an imide-based repeat unit through a dehydration reaction. The imide-based repeat unit may be represented by the following Formula A.

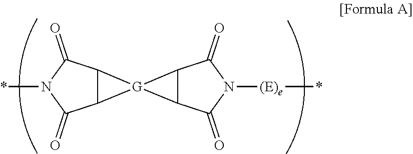

In Formula A, E, G, and e are as described above.

For example, the imide-based repeat unit may comprise a repeat unit represented by the following Formula A-1, but it is not limited thereto.

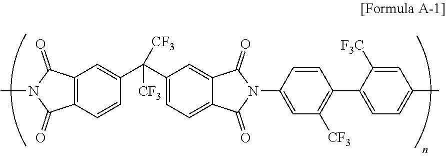

In Formula A-1, n is an integer of 1 to 400.

The dicarbonyl compound is not particularly limited, but it may be, for example, a compound represented by the following Formula 3.

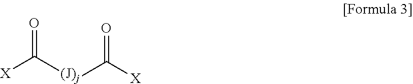

In Formula 3, J is selected from a substituted or unsubstituted divalent C₆-C₃₀ aliphatic cyclic group, a substituted or unsubstituted divalent C₄-C₃₀ heteroaliphatic cyclic group, a substituted or unsubstituted divalent C₆-C₃₀ aromatic cyclic group, a substituted or unsubstituted divalent C₄-C₃₀ heteroaromatic cyclic group, a substituted or unsubstituted C₁-C₃₀ alkylene group, a substituted or unsubstituted C₂-C₃₀ alkenylene group, a substituted or unsubstituted C₂-C₃₀ alkynylene group, —O—, —S—, —C(═O)—, —CH(OH)—, —S(═O)₂—, —Si(CH₃)₂—, —C(CH₃)₂—, and —C(CF₃)₂—. j is selected from integers of 1 to 5. When j is 2 or more, the Js may be the same as, or different from, each other. X is a halogen atom. Specifically, X may be F, Cl, Br, I, or the like. More specifically, X may be Cl, but it is not limited thereto.

(J)ⱼ in the above Formula 3 may be selected from the groups represented by the following Formulae 3-1a to 3-14a, but it is not limited thereto.

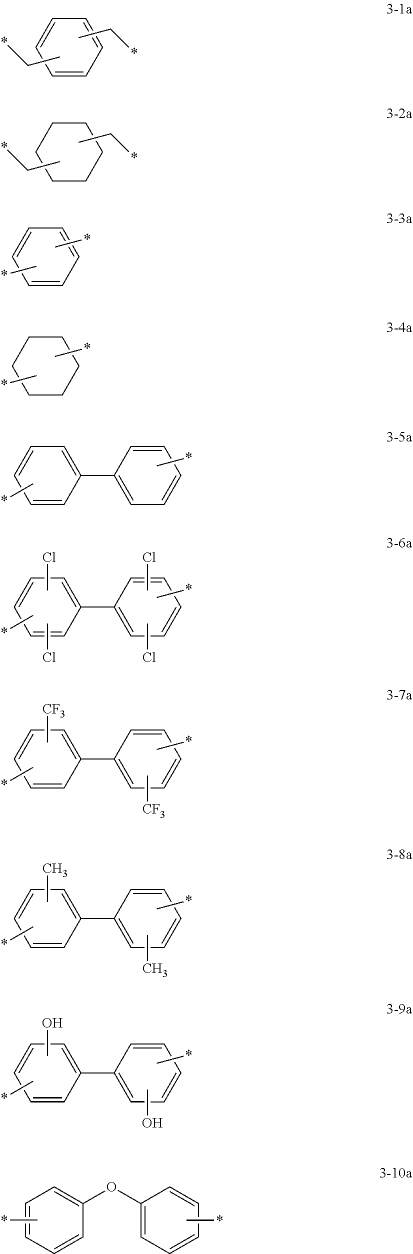

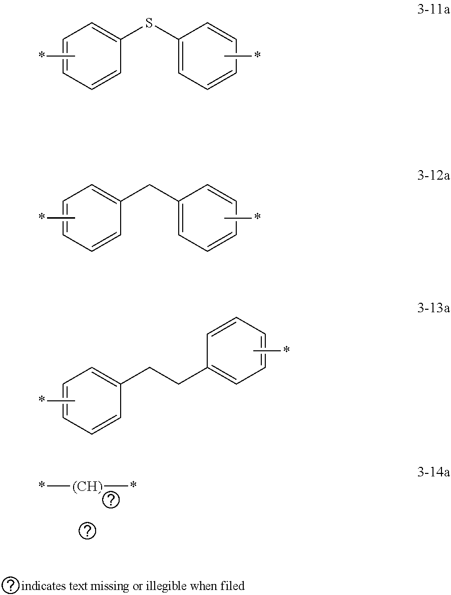

Specifically, (J)ⱼ in the above Formula 3 may be selected from the groups represented by the following Formulae 3-1b to 3-8b, but it is not limited thereto.

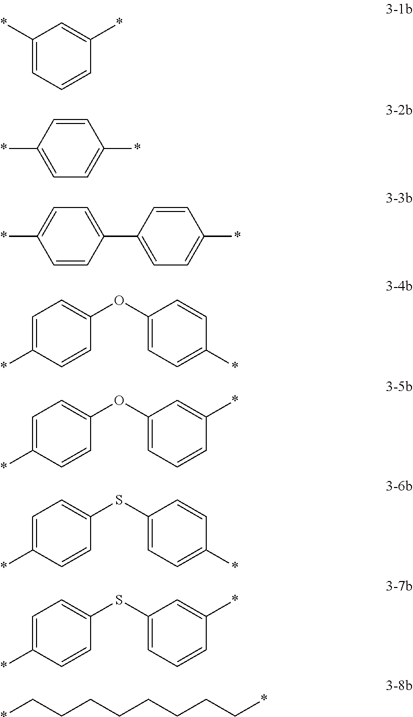

More specifically, (J)ⱼ in Formula 3 may be the group represented by the above Formula 3-1b, the group represented by the above Formula 3-2b, the group represented by the above Formula 3-3b, or the group represented by the above Formula 3-8b.

In an embodiment, one kind of a dicarbonyl compound may be used alone, or a mixture of at least two kinds of dicarbonyl compounds different from each other may be used, as the dicarbonyl compound. If two or more dicarbonyl compounds are used, at least two dicarbonyl compounds in which (J)ⱼ in the above Formula 3 is selected from the groups represented by the above Formulae 3-1b to 3-8b may be used as the dicarbonyl compound.

In another embodiment, the dicarbonyl compound may be an aromatic dicarbonyl compound that contains an aromatic structure.

For example, the dicarbonyl compound may comprise a first dicarbonyl compound and/or a second dicarbonyl compound different from the first dicarbonyl compound.

The first dicarbonyl compound and the second dicarbonyl compound may be an aromatic dicarbonyl compound, respectively.

The first dicarbonyl compound and the second dicarbonyl compound may be aromatic dicarbonyl compounds different from each other, but they are not limited thereto.

If the first dicarbonyl compound and the second dicarbonyl compound are an aromatic dicarbonyl compound, respectively, they comprise a benzene ring. Thus, they can contribute to improvements in the mechanical properties such as surface hardness and tensile strength of a film thus produced that comprises the polyamide-based resin.

The dicarbonyl compound may comprise terephthaloyl chloride (TPC), isophthaloyl chloride (IPC), and 1,1′-biphenyl-4,4′-dicarbonyl dichloride (BPDC), as represented by the following formulae, or a combination thereof. But it is not limited thereto.

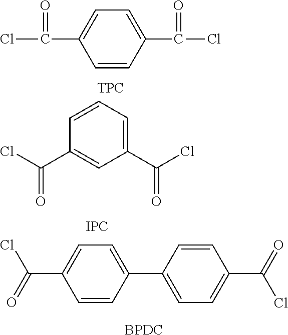

For example, the first dicarbonyl compound may comprise BPDC, and the second dicarbonyl compound may comprise TPC, but they are not limited thereto.

Specifically, if BPDC is used as the first dicarbonyl compound and TPC is used as the second dicarbonyl compound in a proper combination, a film that comprises the polyamide-based resin thus produced may have high oxidation resistance.

Alternatively, the first dicarbonyl compound may comprise IPC (isophthaloyl chloride), and the second dicarbonyl compound may comprise TPC, but they are not limited thereto.

Specifically, if IPC is used as the first dicarbonyl compound and TPC is used as the second dicarbonyl compound in a proper combination, a film that comprises the polyamide-based resin thus produced may have high oxidation resistance, along with reduced manufacturing costs.

The diamine compound and the dicarbonyl compound may be polymerized to form a repeat unit represented by the following Formula B.

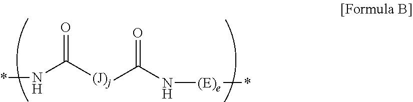

In Formula B, E, J, e, and j are as described above.

For example, the diamine compound and the dicarbonyl compound may be polymerized to form amide repeat units represented by the following Formulae B-1 and B-2.

Alternatively, the diamine compound and the dicarbonyl compound may be polymerized to form amide repeat units represented by the following Formulae B-2 and B-3.

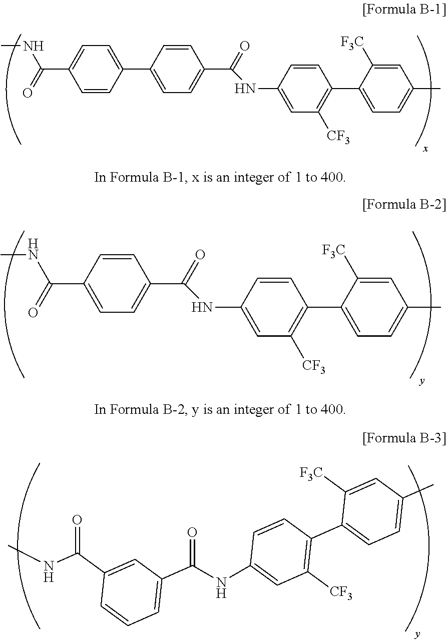

In Formula B-3, y is an integer of 1 to 400.

According to an embodiment, the polyamide-based polymer may comprise a repeat unit represented by the following Formula A and a repeat unit represented by the following Formula B:

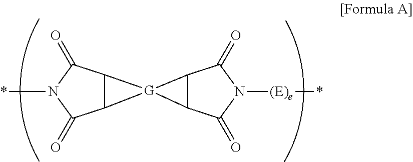

In Formula A, E, G, and e are as described above.

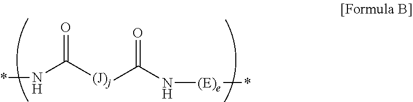

In Formula B, E, J, e, and j are as described above.

The polyamide-based polymer may comprise an imide-based repeat unit and an amide-based repeat unit at a molar ratio of 0:100 to 75:25. For example, the molar ratio of the imide-based repeat unit to the amide-based repeat unit in the polyamide-based polymer may be 2:98 to 70:30, 0:100 to 60:40, 2:98 to 60:40, 5:95 to 60:40, 0:100 to 55:45, 5:95 to 55:45, 0:100 to 50:50, or 5:95 to 50:50, but it is not limited thereto.

Specifically, in the polyamide-based polymer, the molar ratio of the repeat unit represented by the above Formula A to the repeat unit represented by the above Formula B may be 2:98 to 75:25. Specifically, the molar ratio of the repeat unit represented by the above Formula A to the repeat unit represented by the above Formula B may be 2:98 to 70:30, 2:98 to 60:40, 5:95 to 60:40, 5:95 to 55:45, or 5:95 to 50:50, but it is not limited thereto.

The base layer may further comprise one or more selected from the group consisting of fillers, pigments, and UV absorbers as additives.

The process for preparing a polyamide-based film according to an embodiment comprises preparing a polyamide-based polymer solution (S100); casting the solution and then drying it to prepare a gel sheet (S200); and thermally treating the gel sheet (S300).

First, a polyamide-based polymer solution is prepared (S100).

The polyamide-based polymer solution may be prepared by polymerizing a diamine compound, a dicarbonyl compound, and, optionally, a dianhydride compound in an organic solvent.

Specifically, the polyamide-based polymer solution may be prepared by simultaneously or sequentially mixing a diamine compound, a dicarbonyl compound, and, optionally, a dianhydride compound in an organic solvent in a reactor, and reacting the mixture.

As an example, the polymer solution may be prepared by simultaneously mixing and reacting a diamine compound and a dicarbonyl compound in an organic solvent.

As another example, the polymer solution may be prepared by simultaneously mixing and reacting a diamine compound, a dianhydride compound, and a dicarbonyl compound in an organic solvent.

As another example, the step of preparing the polymer solution may comprise first mixing and reacting the diamine compound and the dianhydride compound in a solvent to produce a polyamic acid (PAA) solution; and second mixing and reacting the polyamic acid (PAA) solution and the dicarbonyl compound to form an amide bond and an imide bond. The polyamic acid solution is a solution that comprises a polyamic acid.

Alternatively, the step of preparing the polymer solution may comprise first mixing and reacting the diamine compound and the dianhydride compound in a solvent to produce a polyamic acid solution; subjecting the polyamic acid solution to dehydration to produce a polyimide (PI) solution; and second mixing and reacting the polyimide (PI) solution and the dicarbonyl compound to further form an amide bond. The polyimide solution is a solution that comprises a polymer having an imide repeat unit.

As another example, the step of preparing the polymer solution may comprise first mixing and reacting the diamine compound and the dicarbonyl compound in a solvent to produce a polyamide (PA) solution; and second mixing and reacting the polyamide (PA) solution and the dianhydride compound to further form an imide bond. The polyamide solution is a solution that comprises a polymer having an amide repeat unit.

Details on the diamine compound, the dianhydride compound, and the dicarbonyl compound are as described above.

The content of solids contained in the polymer solution may be 10% by weight to 30% by weight. Alternatively, the content of solids contained in the polymer solution may be 15% by weight to 25% by weight, but it is not limited thereto.

Next, the polymer solution is cast to prepare a gel sheet (S200).

For example, the polymer solution may be extruded, coated, and/or dried on a support to form a gel sheet.

In addition, the casting thickness of the polymer solution may be 200 μm to 700 μm. As the polymer solution is cast to a thickness within the above range, the final film produced after the drying and thermal treatment may have an appropriate and uniform thickness.

The polymer solution may have a viscosity of 80,000 cps to 500,000 cps at room temperature. As the viscosity satisfies the above range, the polymer solution can be cast to a uniform thickness without defects, and a polyamide-based film having a substantially uniform thickness can be formed without local/partial thickness variations during drying.

The polymer solution is cast and then dried at a temperature of 60° C. to 150° C., 70° C. to 150° C., or 80° C. to 150° C., for 5 minutes to 60 minutes to prepare a gel sheet. Specifically, the polymer solution is dried at a temperature of 70° C. to 140° C. for 15 minutes to 40 minutes to prepare a gel sheet.

The solvent of the polymer solution may be partially or totally volatilized during the drying to prepare the gel sheet.

Thereafter, the dried gel sheet is thermally treated to form a polyamide-based film (S300).

The step of thermally treating the gel sheet comprises thermal treatment through at least one heater. In addition, the step of thermally treating the gel sheet may further comprise thermal treatment with hot air.

The thermal treatment with hot air may be carried out in a temperature range of 60° C. to 500° C. for 5 minutes to 200 minutes. Specifically, the thermal treatment of the gel sheet may be carried out in a temperature range of 80° C. to 350° C. at a temperature elevation rate of 2° C./minute to 80° C./minute for 10 minutes to 150 minutes. In such an event, the initial temperature of the thermal treatment of the gel sheet may be 60° C. or higher. Specifically, the initial temperature of the thermal treatment of the gel sheet may be 80° C. to 180° C. In addition, the maximum temperature in the thermal treatment may be 200° C. to 500° C.

The at least one heater may comprise an IR heater. However, the type of the at least one heater is not limited to the above example and may be variously changed. The thermal treatment by the at least one heater may be carried out in a temperature range of 300° C. or higher. Specifically, the thermal treatment by the at least one heater may be carried out for 1 minute to 30 minutes in a temperature range of 300° C. to 500° C.

The base layer may have a thickness of 20 μm or more, 30 μm or more, 40 μm or more, 50 μm or more, or 100 μm or more, and 500 μm or less, 400 μm or less, 300 μm or less, or 200 μm or less. As a specific example, the thickness of the base layer may be 20 μm to 500 μm, more specifically 40 μm to 200 μm or 50 μm to 200 μm.

Functional Layer

The multilayer film may further comprise a functional layer. The functional layer may be formed on the primer layer; thus, the primer layer may be interposed between the functional layer and the base layer.

The functional layer may be a hard coating layer, an optically clear adhesive layer, a printing coating layer, an anti-fingerprint layer, an antistatic layer, an anti-glare layer, an anti-reflection layer, or the like, but it is not particularly limited thereto.

For example, the functional layer may be at least one selected from the group consisting of a hard coating layer, an optically clear adhesive layer, and a printing coating layer.

According to an embodiment, the multilayer film may further comprise a hard coating layer formed on the primer layer. The hard coating layer may enhance the mechanical properties and/or optical properties of the multilayer film.

The hard coating layer may comprise at least one of an organic component, an inorganic component, and an organic-inorganic composite component as a hard coating agent. As an example, the hard coating layer may comprise an organic resin. Specifically, the organic resin may be a curable resin. Accordingly, the hard coating layer may be a curable coating layer.

Specifically, the hard coating layer may comprise at least one selected from the group consisting of a urethane acrylate-based compound, an acrylic ester-based compound, and an epoxy acrylate-based compound. More specifically, the hard coating layer may comprise a urethane acrylate-based compound and an acrylic ester-based compound.

The content of the organic resin may be 30 to 100% by weight based on the total weight of the hard coating layer. Specifically, the content of the organic resin may be 40 to 90% by weight, or 50 to 80% by weight, based on the total weight of the hard coating layer.

The hard coating layer may optionally further comprise a filler. The filler may be, for example, inorganic particles. Examples of the filler include silica, barium sulfate, zinc oxide, and alumina. The filler may have a particle diameter of 1 nm to 1,000 nm. The content of the filler may be 25% by weight or more, 30% by weight or more, or 35% by weight or more, and 50% by weight or less, 45% by weight or less, or 40% by weight or less, based on the total weight of the functional layer.

The hard coating layer may further comprise a photoinitiator. The photoinitiator may be used alone or in combination of two or more different types.

In addition, the hard coating layer may further comprise additives such as antifouling agents, antistatic agents, surfactants, UV absorbers, UV stabilizers, anti-yellowing agents, leveling agents, and dyes to improve color values. The content of the additives may be variously adjusted within a range that does not impair the physical properties of the hard coating layer. For example, it may be 0.01 to 10% by weight based on the total weight of the hard coating layer, but it is not limited thereto.

The hard coating layer may have a thickness of 2 μm or more, 3 μm or more, 5 μm or more, or 10 μm or more, and 50 μm or less, 30 μm or less, 20 μm or less, or 10 μm or less. For example, the thickness of the hard coating layer may be 2 μm to 20 μm. Specifically, the thickness of the hard coating layer may be 5 μm to 20 μm.

According to another embodiment, the multilayer film may further comprise a printing coating layer formed on the primer layer.

The printing coating layer may comprise a binder resin, for example, an ester-based compound, a urethane-based compound, an epoxy-based compound, or a mixture thereof.

Specifically, the ester-based compound may comprise at least one selected from the group consisting of a phthalic acid resin, an isophthalic acid resin, and a terephthalic acid resin; the urethane-based compound may comprise a resin in which an isocyanate compound such as diphenylmethane diisocyanate, toluene diisocyanate, hexamethylene diisocyanate, and isophorone diisocyanate and a polyol are polymerized; and the epoxy compound may comprise at least one selected from the group consisting of a bisphenol A-type epoxy resin, a brominated bisphenol A-type epoxy resin, a novolak resin, and a glycidyl amine-based resin.

The printing coating layer may further comprise a pigment or a dye. The pigment may be an inorganic pigment such as carbon black, barium sulfate, calcium carbonate, titanium oxide, yellow iron oxide, black iron, chrome yellow, chrome vermilion, cadmium yellow, cadmium red, royal blue, an organic pigment such as insoluble azos, soluble azos, phthalocyanines, quinacridones, polyazos, or a mixture thereof.

The printing coating layer may be formed by coating a printing coating layer composition on the primer layer, and the coating may be carried out using a silk screen or thermal transfer.

As an example, the printing coating layer composition may be a thermosetting resin composition. The thermosetting resin composition may comprise a binder resin, a pigment, and a solvent. Specifically, the thermosetting resin composition may comprise to 50% by weight of the binder resin, 1 to 20% by weight of the pigment, and 40 to 80% by weight of the solvent based on the total weight of the thermosetting resin composition.

The solvent may be ketone-based or alcohol-based. Specifically, the solvent may be ketone-based such as methyl ethyl ketone, methyl isobutyl ketone, cyclohexanone, 2-heptanone, and 3-heptanone; alcohol-based such as ethanol, propanol, butanol, hexanol, cyclohexanol, ethylene glycol, diethylene glycol, and glycerin; or a mixture thereof.

According to an embodiment, the thermosetting resin composition may further comprise an additive. Specifically, the additive may be at least one selected from the group consisting of a leveling agent, a dispersant, and a thickener. According to an embodiment, the thermosetting resin composition may comprise the additive in amount of 1 to 10% by weight based on the total weight of the thermosetting resin composition.

The printing coating layer may have a thickness of 1 μm to 50 μm. For example, the thickness of the printing coating layer may be 3 to 50 μm, 3 to 20 μm, 10 to 50 μm, to 40 μm, 20 to 50 μm, 15 to 20 μm, 10 to 15 μm, 2 to 10 μm, 5 to 10 μm, or 2 to 7 μm.

According to still another embodiment, the multilayer film may further comprise an optically clear adhesive layer formed on the primer layer.

The optically clear adhesive layer may comprise an acrylic-based resin, an epoxy-based resin, a urethane-based resin, or the like, but it is not particularly limited thereto.

As an example, the optically clear adhesive layer may comprise an acrylic-based resin, and it may be formed by reacting one or two or more acrylic compounds. The acrylic-based compound may be, for example, at least one selected from 2-ethylhexyl acrylate, 4-hydroxybutyl acrylate, methyl acrylate, acrylic acid, and the like. The reaction of the acrylic-based compound may be carried out in a solvent, and examples of the solvent include ethyl acetate, butyl acetate, toluene, or a mixed solvent thereof.

The optically clear adhesive layer may further comprise a photoinitiator. For example, 2,2′-azobisisobutyronitrile (AIBN), benzoyl peroxide (BPO), or the like may be used as the photoinitiator.

The optically clear adhesive layer may further comprise a crosslinking agent. For example, a glycidyl-based crosslinking agent, an isocyanate-based crosslinking agent, an epoxy-based crosslinking agent, or a mixture thereof may be used as the crosslinking agent. The content of the crosslinking agent may be 0.2 to 0.6 part by weight based on 100 parts by weight of the resin used for preparing the optically clear adhesive layer.

The optically clear adhesive layer may further comprise organic or inorganic particles. For example, the organic particles may comprise particles comprising at least one of polybutyl acrylate (PBA) and polymethyl methacrylate (PMMA). The content of the organic or inorganic particles may be 1 to 10 parts by weight based on 100 parts by weight of the resin used for preparing the optically clear adhesive layer.

As an example, the optically clear adhesive layer may be formed by coating the optically clear adhesive layer composition on the primer layer of the multilayer film. As another example, the optically clear adhesive layer is prepared in advance in the form of a sheet, which may be attached onto the primer layer of the multilayer film.

The optically clear adhesive layer may have a thickness of 30 μm or more, 40 μm or more, or 50 μm or more, and 200 μm or less, 150 μm or less, or 100 μm or less.

### Effects and Uses

As the multilayer film according to an embodiment is provided with a primer layer of a specific composition comprising a polyester-based resin on a polyamide-based base layer, the adhesive strength with a hard coating layer and an OCA layer to be coated on the surface thereof is excellent, as well as the optical and mechanical properties are also excellent.

Accordingly, the multilayer film according to an embodiment can be provided with various functional layers such as a hard coating layer, an anti-fingerprint layer, an antistatic layer, an anti-glare layer, an anti-reflection layer, and an optically clear adhesive layer for implementing the characteristics required for a cover window of a display device such as a flexible display device.

The multilayer film according to an embodiment may be employed in a display device. For example, the multilayer film according to an embodiment may be applied as a cover window of a display device. The display device may be a flexible display device. As an example, it may be a foldable display device.

The display device according to another embodiment comprises a display unit; and a cover window disposed on the viewing side of the display unit, wherein the multilayer film described above is applied as the cover window.

An adhesive layer may be formed between the cover window and the display panel. For example, the adhesive layer may comprise an optically transparent adhesive.

The display panel (20) may be a liquid crystal display (LCD) panel. Alternatively, the display panel (20) may be a light-emitting diode (LED) display panel.

### MODE FOR THE INVENTION

The embodiments described below are provided to help understanding, and the scope of implementation is not limited thereto.

### Preparation Example 1A: Base Layer Film

A 1-liter glass reactor equipped with a temperature-controllable double jacket was charged with dimethylacetamide (DMAc) at 20° C. under a nitrogen atmosphere. Then, 2,2′-bis(trifluoromethyl)-4,4′-diaminophenyl (TFDB) was slowly added thereto for dissolution thereof. Thereafter, 2,2′-bis(3,4-dicarboxyphenyl)hexafluoropropane dianhydride (6-FDA) as a dianhydride compound was slowly added thereto, and the mixture was stirred for 1 hour. Then, terephthaloyl chloride (TPC) and isophthaloyl chloride (IPC) as a dicarbonyl compound were added thereto, followed by stirring thereof for 1 hour, thereby preparing a polymer solution. The types and molar ratios of monomers for the preparation of the polymer solution were adjusted as shown in Table 1 below.

The polymer solution thus obtained was coated onto a glass plate and then dried with hot air at 80° C. for 30 minutes. It was detached from the glass plate, fixed to a pin frame, and thermally treated in a temperature range of 80° C. to 300° C. at a temperature elevation rate of 2° C./minute to obtain a polyamide-based film having a thickness of 50 μm.

### Preparation Examples 1B to 1D: Base Layer Film

The procedures of Preparation Example 1A were repeated to prepare films of Preparation Examples 1B to 1D, except that the types and molar ratios of monomers for the preparation of the polymer solution were changed as shown in Table 1 below.

TABLE 1

| | | Composition of a base layer film | | | |
|---|---|---|---|---|---|
| | | Prep. Ex. 1A | Prep. Ex. 1B | Prep. Ex. 1C | Prep. Ex. 1D |
| Monomer | Diamine | TFDB 100 | TFDB 100 | TFDB 100 | ODA 100 |
| composition | compound | | | | |
| (part by mole) | Dianhydride | 6-FDA 5 | 6-FDA 10 | — | PMDA 100 |
| | compound | | BPDA 43.5 | | |
| | Dicarbonyl | TPC 70 | TPC 46.5 | TPC 60 | — |
| | compound | IPC 25 | | IPC 40 | |

| Molar ratio of amide:imide | 95:5 | 46.5:53.5 | 100:0 | 0:100 |
|---|---|---|---|---|
| Polymer type | Polyamide-imide | Polyamide-imide | Polyamide | Polyimide |
| | (PAI) | (PAI) | (PA) | (PI) |

TFDB: 2,2′-bis(trifluoromethyl)-4,4′-diaminophenyl,
ODA: oxydianiline,
6-FDA: 2,2′-bis(3,4-dicarboxyphenyl)hexafluoropropane dianhydride,
BPDA: 3,3′,4,4′-biphenyltetracarboxylic dianhydride,
TPC: terephthaloyl chloride,
IPC: isophthaloyl chloride,
PMDA: pyromellitic dianhydride

### Preparation Example 2: Optically Clear Adhesive (OCA)

100 parts by weight of a mixture of 2-ethylhexyl acrylate and 4-hydroxybutyl acrylate (80:20, w/w), 4 parts by weight of organic particles (a core-shell structure of core: polybutyl acrylate (PBA) and shell: polymethacrylate (PMMA), a particle size of 130 nm, and a refractive index of 1.48), and 0.005 part by weight of a photoinitiator (Irgacure™ 651) were mixed in a glass vessel. The dissolved oxygen in the glass vessel was replaced with nitrogen gas, and the polymerization reaction was carried out by irradiating ultraviolet rays using a low-pressure lamp (BL Lamp, Sankyo) for several minutes. As a result, a (meth)acrylic-based copolymer having a viscosity of about 1,000 eps and a refractive index of 1.47 to 1.48 containing organic particles was obtained. Here, 0.35 part by weight of a photoinitiator (Irgacure™ 184) was added to prepare an adhesive composition. The adhesive composition was coated on a polyester-based film (release film, PET, 50 μm in thickness) to form an adhesive film having a thickness of 100 μm. The upper surface of the adhesive film was covered with a release film having a thickness of 75 μm, and both sides were then irradiated with a low-pressure lamp (BL Lamp, Sankyo) for about 6 minutes to obtain an optically clear adhesive (OCA) sheet.

### Preparation Example 3: Hard Coating Layer Composition

54.32 parts by weight of a urethane acrylate oligomer (PU2050, Miwon Specialty Chemical), 23.28 parts by weight of a multifunctional acrylate monomer (M300, Miwon Specialty Chemical), 19.4 parts by weight of a silica sol (MA-ST, Nissan Chemical) in which fine silica particles having an average particle diameter of 10 to 15 nm were dispersed in methanol in 30% by weight, and 3 parts by weight of a photoinitiator (I-184, BASF) were mixed to prepare a hard coating layer composition.

### Preparation Example 4: Printing Coating Layer Composition

50% by weight of a colored pigment (carbon black), 2% by weight of a polymer dispersant (BYK-P104S), 35% by weight (based on solids content) of an acrylic resin, and 13% by weight of ethyl acetate were compounded and pre-mixed for 30 minutes, which was then milled (6 to 8 passes) with Dyno™ Mill such that the particle size distribution was 10 μm or less. 20% by weight of the mill base thus prepared, 60% by weight of ethyl acetate, 18.6% by weight (based on solids content) of an acrylic resin, and 1.4% by weight of a silane-based compound (γ-glycidoxypropyl trimethoxysilane, trade name Silquest A-187) were mixed and stirred to prepare a printing coating layer composition.

### Example 1: Preparation of a Multilayer Film

Step (1): Preparation of a Primer Layer Composition

A polyester-based resin (PLASCOAT 446, GOO Chemical, Japan) and a polyurethane-based resin (solids content 28% by weight, H-15, DKS Co. Ltd., Japan) were mixed at a weight ratio of 7:3 (weight ratio of solids content), and a mixed solvent of water (H₂O) and isopropyl alcohol (IPA) at a weight ratio of 85:15 was compounded therewith, followed by stirring thereof at room temperature for 30 minutes to prepare a primer layer composition.

Step (2): Formation of a Primer Layer

The primer layer composition obtained in the above step was coated onto one side of the base layer obtained in Preparation Example 1 with a bar coater and dried to form a primer layer. The coating amount was controlled by the size of the bar, and the thickness of the primer layer upon drying was measured with an optical thickness meter (Film Metrics F-20), which is shown in Table 2 below.

As a result, a multilayer film in which a primer layer was formed on a base layer was obtained.

### Examples 2 to 12

The same procedures as in Example 1 were repeated to prepare a multilayer film, except that the film used for the base layer, the components and contents of the primer layer composition, and the thickness of the primer layer were changed as shown in Table 2 below.

### Comparative Examples 1 to 3

The same procedures as in Example 1 were repeated to prepare a multilayer film, except that a polyester-based resin was not added during the preparation of the primer layer composition, a polyurethane-based resin (solids content 28% by weight, H-15, DKS Co. Ltd., Japan) and an acrylic-based resin (solids content 55% by weight, PRIMAL AC-26, Dow Chemical) were blended at a weight ratio (weight ratio of solids content), and the composition of the solvent in the primer layer composition and the thickness of the primer layer were changed as shown in Table 2 below.

### Comparative Example 4

The same procedures as in Example 1 were repeated to prepare a multilayer film, except that the polyimide (PI) film of Preparation Example 1D was used as the base layer, and the components and contents of the primer layer composition were changed as shown in Table 2 below.

### Comparative Example 5

The polyamide-imide film obtained in Preparation Example 1A was used as a base layer as it was without forming a primer layer.

TABLE 2

| | | Primer layer composition | | | | Primer layer |
|---|---|---|---|---|---|---|
| | | Polymer resin (weight ratio) | | | Solvent | thickness |
| | Base layer | Ester | Urethane | Acryl | H₂O:IPA | (μm) |
| Ex. 1 | Prep. Ex. 1A (PAI) | 7 | 3 | 0 | 85:15 | 0.07 |
| Ex. 2 | Prep. Ex. 1A (PAI) | 7 | 3 | 0 | 85:15 | 0.3 |
| Ex. 3 | Prep. Ex. 1A (PAI) | 9 | 1 | 0 | 85:15 | 0.07 |
| Ex. 4 | Prep. Ex. IC (PA) | 9 | 1 | 0 | 85:15 | 0.3 |
| Ex. 5 | Prep. Ex. 1A (PAI) | 9 | 1 | 0 | 85:15 | 0.75 |
| Ex. 6 | Prep. Ex. 1B (PAI) | 9 | 1 | 0 | 80:20 | 0.07 |
| Ex. 7 | Prep. Ex. 1A (PAI) | 9 | 1 | 0 | 100:0 | 0.75 |
| Ex. 8 | Prep. Ex. 1A (PAI) | 9 | 1 | 0 | 80:20 | 0.75 |
| Ex. 9 | Prep. Ex. 1A (PAI) | 7 | 3 | 0 | 80:20 | 0.3 |
| Ex. 10 | Prep. Ex. 1A (PAI) | 7 | 3 | 0 | 75:25 | 0.75 |
| Ex. 11 | Prep. Ex. 1A (PAI) | 9 | 1 | 0 | 50:50 | 0.75 |
| Ex. 12 | Prep. Ex. 1A (PAI) | 9 | 1 | 0 | 80:20 | 1.35 |
| C. Ex. 1 | Prep. Ex. 1A (PAI) | 0 | 8 | 2 | 85:15 | 0.07 |
| C. Ex. 2 | Prep. Ex. 1A (PAI) | 0 | 8 | 2 | 75:25 | 0.3 |
| C. Ex. 3 | Prep. Ex. 1A (PAI) | 0 | 0 | 10 | 75:25 | 0.07 |
| C. Ex. 4 | Prep. Ex. 1D (PI) | 9 | 1 | 0 | 75:25 | 0.07 |
| C. Ex. 5 | Prep. Ex. 1A (PAI) | — | — | — | — | — |

### Test Example 1: Adhesive Strength Between the Primer Layer and the Base Layer (Cross-Cut Test)

The adhesive strength between the primer layer and the base layer of a film sample was evaluated by a cross-cut test. According to the ASTM D3359 standard (Method B), the surface of the primer layer was cut in a grid shape at regular intervals, an adhesive tape (Nitto Tape 50B) was attached and then detached, and the degree of detachment of grid units from the surface was evaluated. It was graded from 0B to 5B according to the following criteria, and 5B was evaluated as the best (see FIG. 4).
5B: the cut surface was clean, and the square of grid was not detached (0% of the grid area)
4B: small pieces of coating were detached at intersections (less than 5% of the grid area)
3B: small pieces of coating were detached along the edges and at cut-off intersections (5-15% of the grid area)
2B: the cut edge of coating and a part of the rectangle were detached (15-35% of the grid area)
1B: the coating was largely peeled off along the edge of the cut surface, and the squares were detached (35-65% of the grid area)
0B: the coating was peeled off, and the degree of detachment of the squares became more severe (greater than 65% of the grid area)

### Test Example 2: Adhesive Strength Between the Hard Coating Layer and the Base Layer (Cross-Cut Test)

A hard coating layer was formed on the primer layer of a film sample, and the adhesive strength between the hard coating layer and the base layer was evaluated by a cross-cut test.

First, the hard coating layer composition obtained in Preparation Example 3 was coated onto the primer layer of a film sample (or directly coated onto the base layer if no primer layer was present) by a die coating method. The solvent was dried off at 80° C. for about 1 minute, and it was then cured by irradiating an ultraviolet ray of a high-pressure mercury lamp at a light dose of 1,000 mJ/cm². As a result, a film in which a hard coating layer having a thickness of 5 μm on the based layer and primer layer was obtained.

Thereafter, a cross-cut test was carried out on the surface of the hard coating layer according to ASTM D 3359 (Method B) standard as in Test Example 1.

### Test Example 3: Adhesive Strength Between the Printing Coating Layer and the Base Layer (Cross-Cut Test)

A printing coating layer was formed on the primer layer of a film sample, and the adhesive strength between the printing coating layer and the base layer was evaluated by a cross-cut test.

First, the printing coating layer composition obtained in Preparation Example 4 was coated onto the primer layer of a film sample (or directly coated onto the base layer if no primer layer was present) by a silk screen coating method. It was subjected to solvent drying and thermal curing at 80° C. for about 30 minutes. As a result, a film in which a printing coating layer having a thickness of 3.0 μm on the based layer and primer layer was obtained.

Thereafter, a cross-cut test was carried out on the surface of the printing coating layer according to ASTM D 3359 (Method B) standard as in Test Example 1.

### Test Example 4: Adhesion Strength Between the Optically Clear Adhesive Layer and the Base Layer (180° Peel Strength)

An optically clear adhesive (OCA) layer was formed on the primer layer of a film sample, and the adhesive strength between the optically clear adhesive layer and the base layer was evaluated by a 180° peel strength test.

First, the OCA sheet obtained in Preparation Example 2 was attached to the primer layer of a film sample (or directly coated onto the base layer if no primer layer was present) by reciprocating a rubber-coated roller at a load of 2 kg and a speed of 5 mm/s once. As a result, a film having an OCA layer on the base layer and the primer was obtained.

180° peel strength was measured for the OCA layer at a speed of 300 mm/minute according to the ASTM D903 standard using a universal testing machine (UTM)(see FIG. 5).

### Test Example 5: Surface Energy

The surface energy was obtained by measuring the contact angle of a test solution (deionized water, diiodomethane) on the surface of the primer layer (base layer if no primer layer was present) of a film sample using MSA (mobile surface analyzer) of KRUSS by the sessile drop method (see FIG. 6).

First, deionized water with known surface tension was dropped, and the contact angle was obtained, which procedure was repeated five times to obtain an average of the five contact angle values thus obtained. Similarly, diiodomethane with known surface tension was dropped, and the contact angle was obtained, which procedure was repeated five times to obtain an average of the five contact angle values thus obtained. Thereafter, the averages of the contact angles for deionized water and diiodomethane were used to calculate the surface energy according to the following Young's Equation.

σₛ=σₛᵢ+σᵢ·cos θ

Here, Θ is the contact angle of a liquid to a film, σᵢ is the surface tension of the liquid, σₛ the surface energy of the film, and σₛᵢ is the interfacial tension between the film and the liquid.

The interfacial tension between the film and the liquid can be obtained by the known Owens-Wendt-Rabel-Kaelble method. For more specific methods, reference may be made to known literature (e.g., Supplementary Information—Surface energy and Wettability of van der Waals structures, Nanoscale, Issue 10, 2016).

### Test Example 6: Measurement of Light Transmittance and Haze

The total transmittance and haze were measured using a haze meter NDH-5000W manufactured by Nippon Denshoku Kogyo in accordance with the JIS K 7136 standard.

### Test Example 7: Measurement of Yellow Index

The yellow index (YI) was measured with a spectrophotometer (UltraScan PRO, Hunter Associates Laboratory) under the conditions of d65 and 10° in accordance with the ASTM-E313 standard.

The results of the Test Examples are shown in the table below.

TABLE 3

| | | | | | Cross-cut test | | | |
|---|---|---|---|---|---|---|---|---|
| | Surface | | Light | | | Hard | Printing | Adhesive layer |
| | energy | Haze | transmittance | | Primer | coating | coating | peel strength |
| | (dyne) | (%) | (%) | YI | layer | layer | layer | (kgf/inch) |
| Ex. 1 | 44 | 0.4 | 89.5 | 2.2 | 5B | 5B | 5B | 1.1 |
| Ex. 2 | 45 | 0.6 | 89.4 | 2.1 | 5B | 5B | 5B | 1.3 |
| Ex. 3 | 40 | 0.5 | 89.3 | 2.3 | 5B | 5B | 5B | 1.3 |
| Ex. 4 | 39 | 0.4 | 89.1 | 2.2 | 5B | 5B | 5B | 1.4 |
| Ex. 5 | 42 | 0.5 | 89.5 | 2.3 | 5B | 5B | 5B | 1.2 |
| Ex. 6 | 38 | 0.4 | 89.3 | 2.2 | 5B | 5B | 5B | 1.2 |
| Ex. 7 | 43 | 0.5 | 89.4 | 2.2 | 5B | 5B | 5B | 0.9 |
| Ex. 8 | 43 | 0.5 | 89.4 | 2.2 | 5B | 5B | 5B | 1.3 |
| Ex. 9 | 45 | 0.6 | 89.4 | 2.1 | 5B | 5B | 5B | 1.3 |
| Ex. 10 | 43 | 0.6 | 89.0 | 2.4 | 5B | 4B | 5B | 0.3 |
| Ex. 11 | 45 | 1.5 | 90.0 | 3.7 | 3B | 3B | 5B | 0.4 |
| Ex. 12 | 28 | 0.8 | 89.0 | 3.2 | 3B | 3B | 3B | 0.2 |
| C. Ex. 1 | 37 | 0.5 | 89.3 | 2.1 | 5B | 5B | 5B | 0.5 |
| C. Ex. 2 | 36 | 0.9 | 89.0 | 2.5 | 5B | 4B | 4B | 0.4 |
| C. Ex. 3 | 32 | 0.5 | 88.9 | 2.4 | 5B | 3B | 3B | 0.5 |
| C. Ex. 4 | 40 | 0.5 | 89.2 | 2.1 | 3B | 3B | 3B | 0.4 |
| C. Ex. 5 | 38 | 0.4 | 88.4 | 2.5 | — | 3B | 3B | 0.3 |

As can be seen from the above table, the multilayer films of Examples 1 to 12 in which a polyamide-based film (PAI or PA) was adopted as a base film, and the primer layer comprised a polyester-based resin overall had high surface energy and were excellent in the cross-cut test of the hard coating layer and the printing coating layer, resulting in high peel strength of the adhesive layer.

In contrast, the multilayer films of Comparative Examples 1 to 3 in which the primer layer comprised no polyester-based resin had low surface energy and were poor in the cross-cut test of the hard coating layer, resulting in low peel strength of the adhesive layer. In addition, the multilayer film of Comparative Example 4 in which a polyimide (PI) was adopted and that of Comparative Example 5 in which no primer layer was formed were poor in the cross-cut test of the hard coating layer, resulting in low peel strength of the adhesive layer.

1. A multilayer film, which comprises a base layer comprising a polyamide-based polymer; and a primer layer formed on the base layer,
wherein the primer layer comprises 60% by weight to 95% by weight of a polyester-based resin based on the total weight of the primer layer.

2. The multilayer film of claim 1, wherein the primer layer further comprises 5% by weight to 40% by weight of a polyurethane-based resin based on the total weight of the primer layer.

3. The multilayer film of claim 1, wherein the primer layer has a thickness of 0.03 μm to 1.0 μm.

4. The multilayer film of claim 1, wherein the surface energy of the primer layer is dynes to 70 dynes.

5. The multilayer film of claim 1, which has a haze of 3% or less, a light transmittance of 85% or more, and a yellow index (YI) of 5 or less.

6. The multilayer film of claim 1, wherein the cross-cut test result of the surface of the primer layer according to the ASTM D3359 standard is 4B or more.

7. The multilayer film of claim 1, wherein the multilayer film further comprises a functional layer,
the primer layer is interposed between the base layer and the functional layer, and
the functional layer is at least one selected from the group consisting of a hard coating layer, an optically clear adhesive layer, and a printing coating layer.

8. The multilayer film of claim 7, wherein the cross-cut test result of the surface of the hard coating layer or the printing coating layer according to the ASTM D3359 standard is 5B or more, and
the optically clear adhesive layer has a 180° peel strength of 0.8 kgf/inch or more to the base layer according to the ASTM D903 standard.

9. A process comprising preparing a multilayer film, which comprises:
preparing a base layer comprising a polyamide-based polymer; and
coating a primer layer composition on the base layer and drying it,
wherein the primer layer composition comprises a polymer resin and a solvent, and
the polymer resin comprises 60% by weight to 95% by weight of a polyester-based resin based on the total solids content of the primer layer composition.

10. The process for preparing a multilayer film of claim 9, wherein the solvent comprises greater than 75% by weight of water and less than 25% by weight of isopropyl alcohol based on the total weight of the solvent.
